(19) United States
(12) Patent Application Publication
(10) Pub. No.: US 2020/0134093 A1
(43) Pub. Date: Apr. 30, 2020

(54) USER FRIENDLY PLOT SUMMARY GENERATION

(71) Applicant: INTERNATIONAL BUSINESS MACHINES CORPORATION, Armonk, NY (US)

(72) Inventors: Jian Jun Wang, Xi'an (CN); Juan Rao, Pudong (CN); Ya Wei Guo, Xi'an (CN); Lin Su, Xi'an (CN); Chen Luo, Beijing (CN)

(21) Appl. No.: 16/171,967

(22) Filed: Oct. 26, 2018

(51) Int. Cl. G06F 17/30; H04N 21/258

(52) U.S. Cl. CPC G06F 17/30843; H04N 21/25891; G06F 17/30828; G06F 17/30719

(57) ABSTRACT

Methods, systems, and computer program products are disclosed for providing a user friendly plot summary of a video for a particular user. According to the method, a plot category of a video can be determined. The method can determine a type of a plot summary of the video for a user based on preferences of the user and the determined plot category of the video. The method can generate a plot summary of the video with the determined type. The method can provide the generated plot summary to the user.

### BACKGROUND

### Technical Field

The present invention relates to the field of video processing, and more specifically, to methods, systems and computer program products for providing a user friendly plot summary of a video for a particular user.

### Description of the Related Art

Watching videos is very popular today. A user usually reads a summary of a video before viewing it to know whether the video is of interest to the user.

### SUMMARY

Example embodiments of the present invention disclose methods, systems, and computer program products for providing a user friendly plot summary of a video for a particular user.

In an aspect, a computer-implemented method is disclosed. According to the method, at least one plot category of a video may be determined. The method may also determines a type of a plot summary of the video for a user based on preferences of the user and the determined at least one plot category of the video. The method may generate a plot summary of the video with the determined type. The generated plot summary may be provided to the user.

In another aspect, a computer system is disclosed. The system may include a computer processor coupled to a computer-readable memory unit, the memory unit including instructions that when executed by the computer processor implements the above method.

In yet another aspect, a computer program product is disclosed. The computer program product includes a computer readable storage medium having program instructions embodied therewith. When executed on one or more processors, the instructions may cause the one or more processors to perform the above method.

It is to be understood that the summary is not intended to identify key or essential features of embodiments of the present invention, nor is it intended to be used to limit the scope of the present invention. Other features of the present invention will become easily comprehensible through the description below.

### BRIEF DESCRIPTION OF THE DRAWINGS

Through the more detailed description of some embodiments of the present invention in the accompanying drawings, the above and other objects, features and advantages of the present invention will become more apparent, wherein the same reference generally refers to the same components in the embodiments of the present invention.

FIG. 1 depicts a cloud computing node according to an embodiment of the present invention;

FIG. 2 depicts a cloud computing environment according to an embodiment of the present invention;

FIG. 3 depicts abstraction model layers according to an embodiment of the present invention;

FIG. 4 depicts a flow diagram illustrating a method for providing a user friendly plot summary of a video for a user according to an embodiment of the present invention;

FIG. 5 depicts a flow diagram illustrating a method for providing a detailed user friendly plot summary of a video for a user according to an embodiment of the present invention;

FIG. 6 shows a plot summary of a film for user A on an on-line video web site according to an embodiment of the present invention; and

FIG. 7 shows another plot summary of the film shown in FIG. 6 for user B on the on-line video website according to an embodiment of the present invention.

Throughout the drawings, the same or similar reference numerals represent the same or similar elements.

### DETAILED DESCRIPTION

Some embodiments will be described in more detail with reference to the accompanying drawings, in which the embodiments of the present invention have been illustrated. However, the present invention can be implemented in various manners, and thus should not be construed to be limited to the embodiments disclosed herein.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

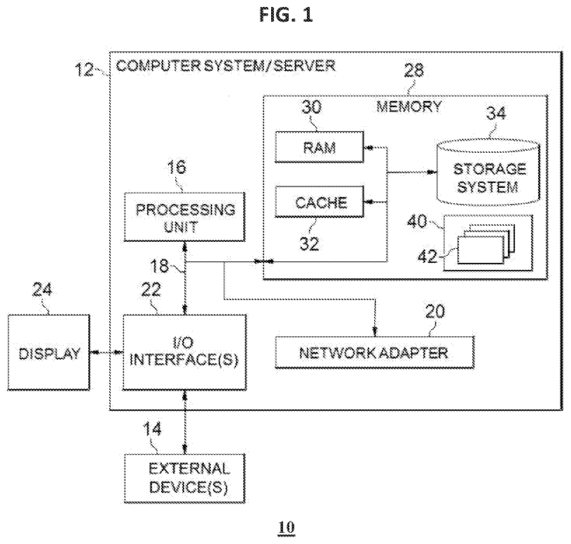

Referring now to FIG. 1, a schematic of an example of a cloud computing node is shown. Cloud computing node 10 is only one example of a suitable cloud computing node and is not intended to suggest any limitation as to the scope of use or functionality of embodiments of the invention described herein. Regardless, cloud computing node 10 is capable of being implemented and/or performing any of the functionality set forth hereinabove.

In cloud computing node 10 there is a computer system/server 12 or a portable electronic device such as a communication device, which is operational with numerous other general purpose or special purpose computing system environments or configurations. Examples of well-known computing systems, environments, and/or configurations that may be suitable for use with computer system/server 12 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 12 may be described in the general context of computer system-executable instructions, such as program modules, being executed by a computer system. Generally, program modules may include routines, programs, objects, components, logic, data structures, and so on that perform particular tasks or implement particular abstract data types. Computer system/server 12 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 1, computer system/server 12 in cloud computing node 10 is shown in the form of a general-purpose computing device. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus.

Computer system/server 12 includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown, such as a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the invention.

Program/utility 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments of the invention as described herein.

Computer system/server 12 may also communicate with one or more external devices 14 such as a keyboard, a pointing device, a display 24, etc.; one or more devices that enable a user to interact with computer system/server 12; and/or any devices (e.g., network card, modem, etc.) that enable computer system/server 12 to communicate with one or more other computing devices. Such communication can occur via Input/Output (I/O) interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples, include, but are not limited to: microcode, device drivers, redundant processing units, external disk drive arrays, RAID systems, tape drives, and data archival storage systems, etc.

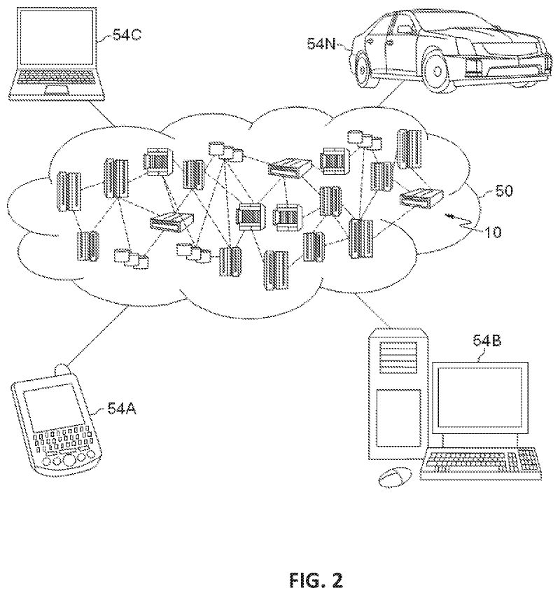

Referring now to FIG. 2, illustrative cloud computing environment 50 is depicted. As shown, cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 2 are intended to be illustrative only and that computing nodes 10 and cloud computing environment 50 can communicate with any type of computerized device over any type of network and/or network addressable connection (e.g., using a web browser).

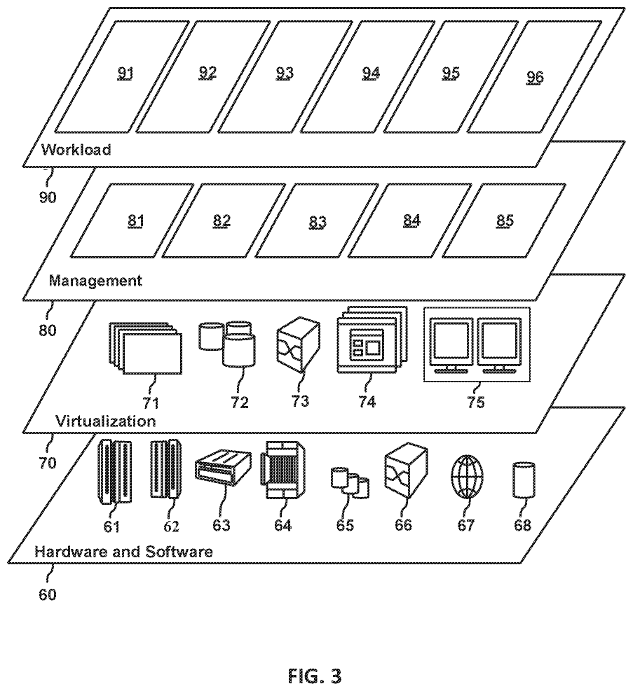

Referring now to FIG. 3, a set of functional abstraction layers provided by cloud computing environment 50 (FIG. 2) is shown. It should be understood in advance that the components, layers, and functions shown in FIG. 3 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and plot summary of videos 96.

Currently a text plot summary of a video can be found on a video web site, so that a user can know what the content in the video is and whether the video is of interest to the user.

In embodiments of the present invention, videos also include presentations with a lot of pages to be displayed in order.

In order to provide better user experience, static picture slides and video clip, e.g., “best scenes”, are also used to provide a plot summary of a video. However, current video web sites generally provide a single type of plot summary, in other words, the type of plot summary may be either text, static picture slides, or video clip. Besides, existing types of plot summaries of a video do not consider the user's preferences. For example, if a user is afraid of watching a horror video, it is not a preferred option to provide the user with a static picture slides plot summary of a horror film or a video clip plot summary of the horror film, which may make the user uncomfortable. However, if a user loves musicals, it is a preferred option to provide the user with a video clip plot summary of a musical.

Embodiments of the present invention provides a user friendly plot summary of a video for a particular user to solve the above problems.

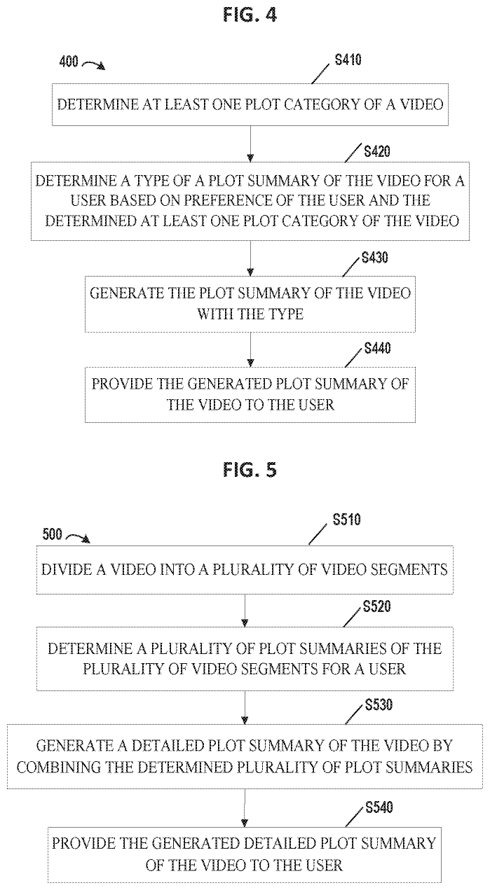

FIG. 4 depicts a flow diagram illustrating a method 400 for providing a user friendly plot summary of a video for a user according to an embodiment of the present invention. Referring to FIG. 4, the process may begin at block S410, in which the one or more processors can determine at least one plot category of a video. The method 400 may proceed to block S420, in which one or more processors can determine a type of a plot summary of the video based on preferences of a user and the determined at least one plot category. At block S430, the one or more processors can generate the plot summary of the video with the determined type. At block S440, the one or more processors can provide the generated plot summary of the video to the user.

At block S410 the at least one plot category of a video may be determined. In some embodiments, the plot category of the video can be determined based on type of story. And the plot category can be at least one of the following: comedy, adventure, fantasy, mystery, thriller, documentary, war, western, romance, drama, horror, action, sci-fi (Science fiction), music, family, and crime, etc. In a further embodiment, some plot categories may include a property of “dynamic” or “static”, which allows for indicating a preference to provide a “dynamic” or “static” plot summary for the video in this category. For example, comedy(dynamic); thriller(dynamic); war(dynamic); romance(static); horror(dynamic); action(dynamic); sci-fi(dynamic); music(dynamic); family(static), and the like. It can be understood that the property of “dynamic” or “static” of a plot category can be defined by users.

In an embodiment, the video may include a plurality of sources, such as subtitles, scripts, voice, posters, comments on the video, or barrages on video websites, etc., and the at least one plot category of the video may be determined based on at least one of the above sources. For example, a classification model between typical specific keywords and the plot categories may be built using training sets in which multiple specific keywords have been specified to belong to multiple specific plot categories first. And a predefined number of keywords of the video may be determined from the above sources using existing technology, such as text analysis technologies, speech to text technologies, image to text technologies, etc. The predefined number of keywords of the video may be mapped to the typical specific keywords using existing semantic analysis technology. The mapped specific keywords may be input into the classification model to obtain the plot categories of the video. Those skilled in the art can understand that the number of the keywords can be specified by the user.

In an embodiment, the property of “dynamic” or “static” of each plot category of the video may be analyzed based on subtitles of the video, scripts of the video, voice of the video, posters of the video, comments on the video on social network, or barrages of the video on video websites, etc. using semantic analysis technology.

In some embodiments, once keywords of the video are determined based on the above sources using existing technology, the semantic analysis technology may be used to determine the plot categories of the video directly instead of using the classification model.

In some embodiments, the plot category may be determined based on a particular actor in the video. In this implementation, the plot category can be identified such as a video including a movie star A, a video including a movie star B, etc. In some other embodiments, the plot category may be determined based on production country of the video, or director of the video, etc.

In some embodiments, the plot category may be determined based on the content of the video, in other words, the plot category can be identified directly by the above keywords of the video. Then different video have different keywords, so their plot categories are different.

In some embodiments, the plot category may be determined based on any combination of the above factors, such as based on both the type of story and the particular actor, etc. For example, {movie star A, action} may be a plot category used.

Referring back to FIG. 4, at block 420, a type of a plot summary of the video may be determined for a user based on preferences of the user and the determined at least one plot category. Since the at least one plot category has been determined at block 410, the preferences of the user may be obtained or determined in advance using many existing methods. The preferences of the user provide a relatively compact description of the user's personal interests.

In some embodiments, a user profile interrelates with the user's preferences in some manner. In many cases the information and the description contained within the user's profile can be used to determine the user's preferences, and the type of plot summary of a video that is likely desirable to the particular user can be determined by analyzing the profile using semantic analysis technology.

In some embodiments, the user preferences may be specified directly by the user who explicitly states the plot categories of the videos that interests the user. In this implementation, multiple options for the plot categories of videos can be provided to the user for selection. For example, the plot categories, such as comedy, adventure, fantasy, mystery, thriller, documentary, war, western, romance, drama, horror, action, sci-fi, music, family, crime, and the like, can be provided for user selection in his/her video preferences, and anyone of the above plot categories can be selected by the user as a dimension of the user preferences.

In another example, options “static” dimension and “dynamic” dimension can also be provided to the users so that another dimension of the user's preferences can be determined.

In an embodiment, a preference weight for a dimension of the user's preferences can also be obtained from the user, for example, three weights “high”, “medium”, “low” can be provided to the user to choose. In yet another embodiment, numerical values of the preference weight can be provided to the user to choose. For example, user A can select {comedy (weight 8), adventure (weight 6), fantasy (weight −6), horror (weight −9), action (weight 3), sci-fi (weight 9), and music (weight 10)} as his preferences. The preferences of user A means user A likes music videos most, and also likes sci-fi videos, comedy videos, adventure videos, action videos in the order of weighted preference, and dislikes fantasy videos and horror videos in order of value of the weighted preferences. User B can select {comedy (weight −8), horror(weight 9), action (weight −3), sci-fi (weight −9), and music(weight −10)} as his preferences. It can be found that user A and user B have totally different preferences. Those skilled in the art will understand that more or less preference weights for a plot category of a video can be provided to the user to choose.

In some embodiments, the preferences of the user can be automatically generated and updated based on a history of video consumption behavior of the user, such as recording the video, viewing the video, and commenting on the video on social network, writing barrages of the video on a video website, and the like. Several methods have been proposed for discovering and updating preferences of a user based on the user' consumption history. These methods rely on explicit input of the user (for example, in the form of user assigned ranking to some videos after viewing them, comments on some videos with known plot categories, barrages input while viewing videos, etc.) to identify which category of videos the user may like and its corresponding preference weight. For example, a plot category of videos that have been viewed more recently may have a higher preference weight than another plot category of videos that have been previously viewed, a plot category of videos that have been viewed more frequently may have a higher preference weight than another plot category of videos that have been less viewed, and the like.

In some embodiments, the user preferences can be automatically generated and updated based on emotion values of the user during the video consumption behavior of the user. For example, wearable devices of the user can be used to detect the user's physiological parameters, such as heartbeat, respiratory frequency, body temperature, and the like. The emotions of the user and the emotion levels can be calculated with some models. The calculated emotions and levels can be used to create or update the preferences of the user and preference weights.

In some embodiments, the user preferences can be obtained from local storage or other sources, such as cloud storages.

Then at block S420 in FIG. 4, a type of a plot summary of the video can be determined based on the preferences of the user and the determined at least one plot category. The existing types of the plot summary include text, static picture slides and video clip. Obtaining the text, static picture slides or video clip plot summary can use existing technology, thus the detailed information is omitted in this description.

In embodiments of the present invention, types of the plot summary also include combination of above two or three types of the plot summary, e.g. combination of text and static picture slides, combination of text and video clip, combination of static picture slides and video clip, combination of text, static picture slides and video clip. Those skilled in the art will understand that a text plot summary can better describe the whole story of the video, and a static picture slides plot summary can better describe static moments of the video, while a video clip plot summary can better describe dynamic moments of the video. Therefore, the plot summary of the video with the better type may be provided for the user based on both the at least one plot category of the video and the preferences of the user.

In some embodiments, the determined at least one plot category of the video can be compared with the preferences of the user to obtain a compared result. If the compared result indicates a match between the determined at least one plot category of the video and the preferences of the user, which indicates that the user may have interests to this video, the type of the plot summary of the video can be a combination of text and video clips, or a combination of text and static picture slides, so as to provide better user experiences.

In some embodiments, if one of the at least one plot category of the video is within the scope of the user's preferences, in other words, one of the at least one plot category of the video has the same semantic meaning with one dimension of the preferences of the user, it can be concluded that the compared result indicates a match. For example, one of the determined at least one plot category of a video is {comedy}, and one dimension of the preference of the user is also {comedy}, so the determined at least one plot category and the preferences of the user are matched. In another example, the determined at least one plot category of a video include following keywords {love story, an interlude of love story}, and dimensions of the preferences of the user include {Romance, music}. Words “love story” and “Romance” have the same semantic meaning for a video, and words “An interlude of love story” and “music” have the same semantic meaning for a video, then it can be concluded that the determined at least one plot category and the preferences of the user are matched.

In some embodiments, if one of the determined at least one plot category of the video is within the scope of the user's preferences and the preference weight of the matched dimension of the user's preferences is greater than a predefined threshold, in other words, one of the determined at least one plot category of the video has the same semantic meaning with one dimension of the user's preferences, and preference weight of the dimension of the user's preferences is greater than the predefined threshold, it can be concluded that the compared result indicates a match. For example, one of the determined at least one plot category of a video is {comedy}, and one dimension of the preferences of the user is {comedy, weight=0.6}, and if the predefined threshold=0.8, then the determined at least one plot category and the preferences of the user are mismatched. However, if the predefined threshold=0.5, then the determined at least one plot category and the preferences of the user are matched. It can be understood that those skilled in the art can define other manners to indicate the match.

In a embodiment, if the compared result indicates a match, and the preferences of the user include “dynamic” dimension, then the type of the plot summary of the video can be determined to be a combination of text and video clips. And if the compared result indicates a match, and the preferences of the user include “static” dimension, the type of the plot summary of the video can be determined to be a combination of text and static picture slides.

In a further implementation, if the compared result indicates a match, and the preferences of the user excludes both “dynamic” dimension and “static” dimension, and the matched at least one category of the video includes a “dynamic” property, the type of the plot summary of the video can be determined to be a combination of text and video clips. And if the compared result indicates a match, and the preferences of the user excludes both “dynamic” dimension and “static” dimension, and the matched at least one category of the video includes a “static” property, the type of the plot summary of the video can be determined to be a combination of text and static picture slides.

For example, if one of the at least one plot category of the video is {comedy}, the plot category includes “static” property, and one dimension of the preferences of the user is {comedy}, it can be concluded that the at least one plot category matches with the preferences of the user. And if the preferences of the user also include “dynamic” dimension, the type of the plot summary of the video can be determined to be a combination of text and video clips. But if the preferences of the user exclude both “dynamic” and “static” dimension, then the type of the plot summary of the video can be determined to be a combination of text and static picture slides.

In a an embodiment, if the compared results indicate a mismatch, which may indicate that the user may have no interest in this video, the type of the plot summary of the video may be determined as one of the following: text, video clip or static picture slides.

In an embodiment, if the compared results indicate a mismatch, and the preferences of the user includes a “dynamic” dimension, the type of the plot summary of the video can be determined to be video clip. And if the compared results indicate a mismatch, and the preferences of the user includes a “static” dimension, the type of the plot summary of the video can be determined to be static picture slides.

In an embodiment, if the compared results indicate a mismatch, and the preferences of the user excludes both a “dynamic” dimension and a “static” dimension, and the at least one category of the video includes a “dynamic” property, the type of the plot summary of the video can be determined to be video clip. If the compared results indicate a mismatch, and the preferences of the user excludes both a “dynamic” dimension and a “static” dimension, and the at least one category of the video includes a “static” property, the type of the plot summary of the video can be determined to be static picture slides.

In an embodiment, if the compared results indicate a mismatch, and the preferences of the user excludes both a “dynamic” dimension and a “static” dimension, and the at least one category of the video excludes both a “dynamic” property and a “static” property, the type of the plot summary of the video can be determined to be text.

For example, if one of the at least one plot category of a video is {comedy}, the plot category includes a “static” property, and dimensions of the preferences of the user exclude {comedy}, it can be concluded that both are mismatched. And if the preferences of the user further include a “dynamic” dimension, the type of the plot summary of the video may be determined to be video clips. However, if the preferences of the user further excludes both a “dynamic” dimension and a “static” dimension, the type of the plot summary of the video can be determined to be static picture slides. Additionally, if the plot category {comedy} excludes both a “dynamic” and a “static” property, the preferences of the user excludes both a “dynamic” dimension and a “static” dimension, the type of the plot summary of the video can be determined to be text.

Referring back to FIG. 4, at block S430, the plot summary of the video with the determined type can be determined. It can be understood that the plot summary with types of text, static picture slides or video clip can be generated using existing technology and stored into a storage in advance. It also can be understood the plot summary of the video with types of text, static picture slides or video clip can be generated on-line. And the plot summary of the video with types of combination of text and static picture slides or combination of text and video clip can be generated based on the plot summary with types of text, static picture slides or video clip.

Referring back to FIG. 4, at block S440, the one or more processors can provide the generated plot summary of the video to the user. In an embodiment, when a requirement of displaying the plot summary of the video to a user is received on a video web site, the plot summary of the video with the determined type can be provided to the user.

In some embodiments, a video may include a lot of details, and a user may have an interest in viewing a detailed plot summary of the video. FIG. 5 depicts a flow diagram illustrating a method 500 for providing a detailed user friendly plot summary of a video for a user according to an embodiment of the present invention. Referring to FIG. 5, the process can begin at block S510, in which one or more processors can divide the video into a plurality of video segments using existing technology. The method 500 then can proceed to block S520, in which the one or more processors may determine a plurality of plot summaries of the plurality of video segments for a user using the method 400 (FIG. 4). At block S530, the one or more processors can generate a detailed plot summary of the video by combining the determined plurality of plot summaries of the plurality of video segments. At block S40, the one or more processors can provide the generated detailed plot summary of the video to the user.

It can be understood that a plurality of plot summaries with types of text, static picture slides or video clip for a plurality of video segments of the video can be generated using existing technology and stored into a storage in advance. When the requirement of displaying a detailed plot summary of the video to a user is received, the plurality of plot summaries of the plurality of video segments of the video can be determined by accessing the storage to save service time. The detailed plot summary of the video can be provided by combining the determined plurality of plot summaries. It can be understood that the detailed plot summary of the video can be generated on-line.

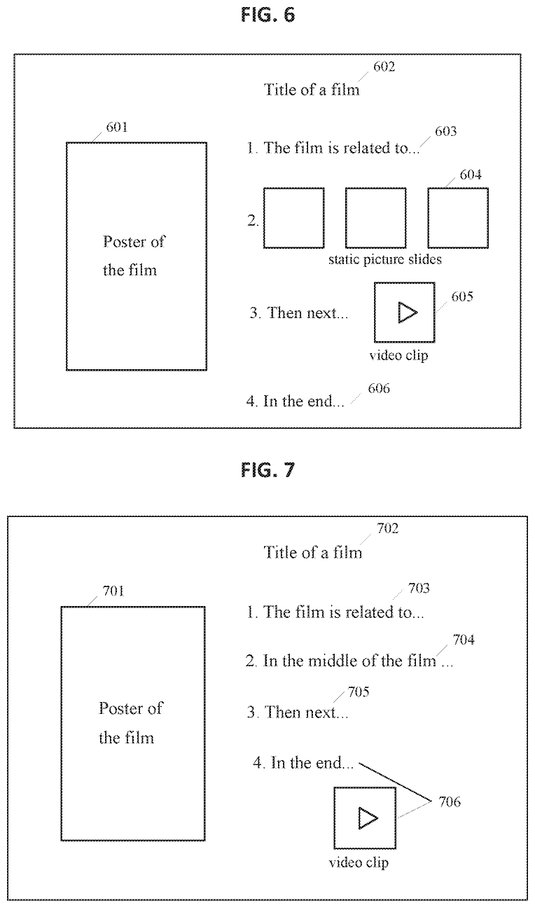

Thus, different plot summaries of the same video can be provided for different users in an on-line video website. FIG. 6 shows a plot summary of a film for user A on an on-line video website, in which 601 indicates the poster of the film, and 602 indicates the title of the film. The film is divided four video segments using existing technology, and 4 plot summaries are determined, their types are text (603), static picture slides (604), combination of text and video clip (605), and text (606) respectively, as shown in FIG. 6. And FIG. 7 shows another plot summary of the same film for user B on the same on-line video website, in which 701 indicates the poster of the film, and 702 indicates the title of the film. While types of 4 plot summaries are text (703), text (704), text (705), and combination of text and video clip (706) respectively, as shown in FIG. 7. It can be found that the 4 plot summaries for user A and user B are not exactly the same due to their different preferences.

Based on the above description of the present invention, those skilled in the art will be readily capable of developing alternative embodiments that have not been described in detail herein, but neither the less are within the scope of the present invention.

It should be noted that the processing of providing a user friendly plot summary of a video for a specific user according to embodiments of this disclosure can be implemented by a computer system/server 12 shown in FIG. 1.

The present invention can be a system, a method, and/or a computer program product at any possible technical detail level of integration. The computer program product can include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium can be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network can include copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention can be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions can execute entirely on the user's computer, partly on the user's computer, as a stand-alone software package, partly on the user's computer and partly on a remote computer or entirely on the remote computer or server. In the latter scenario, the remote computer can be connected to the user's computer through any type of network, including a local area network (LAN) or a wide area network (WAN), or the connection can be made to an external computer (for example, through the Internet using an Internet Service Provider). In some embodiments, electronic circuitry including, for example, programmable logic circuitry, field-programmable gate arrays (FPGA), or programmable logic arrays (PLA) can execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions can be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions can also be stored in a computer readable storage medium that can direct a computer, a programmable data processing apparatus, and/or other devices to function in a particular manner, such that the computer readable storage medium having instructions stored therein includes an article of manufacture including instructions which implement aspects of the function/act specified in the flowchart and/or block diagram block or blocks.

The computer readable program instructions can also be loaded onto a computer, other programmable data processing apparatus, or other device to cause a series of operational blocks to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams can represent a module, segment, or portion of instructions, which includes one or more executable instructions for implementing the specified logical function(s). In some alternative implementations, the functions noted in the blocks can occur out of the order noted in the Figures. For example, two blocks shown in succession may, in fact, be executed substantially concurrently, or the blocks can sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

1. A computer implemented method comprising:
determining, by one or more processors, at least one plot category of a video, the at least one plot category being determined based on semantic analysis to identify a genre of the video;
determining, by one or more processors, a type of plot summary of the video for a user based on preferences of the user and the determined at least one plot category of the video;
generating, by one or more processors, the plot summary of the video with the determined type of plot summary of the video; and
providing, by one or more processors, the generated plot summary to the user.

2. The method according to claim 1, wherein the type of plot summary comprises one of: text; static picture slides; video clips; and a combination of two or three of: text, static picture slides and video clips.

3. The method according to claim 2, wherein determining the type of plot summary of the video comprises:
in response to the determined at least one plot category matching with the preferences of the user, determining, by one or more processors, the type of the plot summary of the video to be one of a combination of text and video clip, or a combination of text and static picture slides.

4. The method according to claim 3, wherein determining the type of plot summary of the video to be one of the combination of text and video clip or the combination of text and picture slides further comprises:
in response to a dynamic dimension being included in the preferences of the user, determining, by one or more processors, the type of plot summary of the video to be the combination of text and video clip;
in response to a static dimension being included in the preferences of the user, determining, by one or more processors, the type of the plot summary of the video to be the combination of text and static picture slides; and
in response to neither a dynamic dimension nor a static dimension being included in the preferences of the user,
determining, by one or more processors, the type of plot summary of the video for the user to be the combination of text and video clip based on a dynamic property being included in the determined at least one category of the video; and
determining, by one or more processors, the type of the plot summary of the video for the user to be the combination of text and static picture slides based on a static property being included in the determined at least one category of the video.

5. The method according to claim 2, wherein determining the type of plot summary of the video further comprises:
in response to the determined at least one plot category not matching with the preferences of the user, determining, by one or more processors, the type of plot summary of the video to be one of: text, video clip or static picture slides.

6. The method according to claim 5, wherein determining the type of plot summary of the video to be one of: text, video clip or static picture slides further comprises:
in response to a dynamic dimension being included in the preferences of the user, determining, by one or more processors, the type of plot summary of the video to be video clip;
in response to a static dimension being included in the preferences of the user, determining, by one or more processors, the type of the plot summary of the video to be static picture slides; and
in response to neither the dynamic dimension nor the static dimension being included in the preferences of the user:
determining, by one or more processors, the type of plot summary of the video for the user to be video clip based on a dynamic property being included in the determined at least one category of the video;
determining, by one or more processors, the type of plot summary of the video for the user to be static picture slides based on a static property being included in the determined at least one category of the video; and
determining, by one or more processors, the type of plot summary of the video to be text based on neither the dynamic property nor the static property being included in the determined at least one category of the video.

7. The method according to claim 1, wherein the plot category comprises at least one of: comedy, adventure, fantasy, mystery, thriller, documentary, war, western, romance, drama, horror, action, sci-fi, music, family, and crime.

8. The method according to claim 1, wherein the plot category is identified with a plurality of keywords obtained based on the video.

9. The method according to claim 1, wherein the at least one plot category is obtained from at least one of: subtitles of the video, scripts of the video, voice of the video, posters of the video, comments on the video, and barrages of the video.

10. The method according to claim 1, wherein the video is a video segment of a plurality of video segments obtained by dividing another video.

11. A computing system comprising one or more computer processors coupled to a computer-readable memory unit, the memory unit comprising instructions that when executed by the one or more computer processors cause the one or more computer processors to:
determine at least one plot category of a video based on semantic analysis to identify a genre of the video;
determine a type of plot summary of the video for a user based on preferences of the user and the determined at least one plot category of the video;
generate the plot summary of the video with the determined type of plot summary of the video; and
provide the generated plot summary to the user.

12. The system according to claim 11, wherein the type of plot summary comprises one of: text; static picture slides; video clip; and a combination of two or three of: text, static picture slides and video clip.

13. The system according to claim 12, wherein the one or more computer processors determine the type of plot summary of the video by executing instructions causing the one or more computer processors to:
in response to the determined at least one plot category matching with the preferences of the user, determine the type of plot summary of the video to be a combination of text and video clip, or a combination of text and static picture slides.

14. The system according to claim 12, wherein the one or more computer processors determine the type of plot summary of the video by executing instructions causing the one or more computer processors to:
in response to the determined at least one plot category not matching with the preferences of the user, determine the type of plot summary of the video to be one of: text, video clip or static picture slides.

15. The system according to claim 11, wherein the video is a video segment of a plurality of video segments obtained by dividing another video.

16. A computer program product, the computer program product comprising a computer readable storage medium having program instructions embodied therewith, the program instructions executable by one or more processors to cause the one or more processors to implements a method comprising:
determining at least one plot category of a video based on semantic analysis to identify a genre of the video;
determining a type of plot summary of the video for a user based on preferences of the user and the determined at least one plot category of the video;
generating the plot summary of the video with the determined type; and
providing the generated plot summary to the user.

17. The computer program product according to claim 16, wherein the type of plot summary comprises one of: text; static picture slides; video clip; and a combination of two or three of text, static picture slides and video clip.

18. The computer program product according to claim 17, wherein determining the type of plot summary of the video comprises:
in response to the determined at least one plot category matching with the preferences of the user, determining the type of plot summary of the video to be a combination of text and video clip, or a combination of text and static picture slides.

19. The computer program product according to claim 17, wherein determining the type of plot summary of the video comprises:
in response to the determined at least one plot category not matching with the preferences of the user, determining the type of plot summary of the video to be one of: text, video clip or static picture slides.

20. The computer program product according to claim 16, wherein the video is a video segment of a plurality of video segments obtained by dividing another video.
